(19) United States
(12) Patent Application Publication
(10) Pub. No.: US 2015/0367490 A1
(43) Pub. Date: Dec. 24, 2015

(54) POWER TOOL

(71) Applicant: HITACHI KOKI CO., LTD., Minato-ku, Tokyo (JP)

(72) Inventors: Shinichirou SATOU, Hitachinaka-City (JP); Yoshihiro HOSHI, Tokyo (JP)

(73) Assignee: HITACHI KOKI CO., LTD., Tokyo (JP)

(21) Appl. No.: 14/767,905

(22) PCT Filed: Feb. 28, 2014
(86) PCT No.: PCT/JP2014/055095

§ 371 Date: Aug. 13, 2015

(30) Foreign Application Priority Data
Mar. 26, 2013 (JP) 2013-063631
Mar. 26, 2013 (JP) 2013-063632

(51) Int. Cl. B25D 16/00

(52) U.S. Cl. CPC B25D 16/006

(57) ABSTRACT

A power tool, which transmits a rotational force of an intermediate shaft to a tool bit, is provided with a gear which converts the rotational force of the intermediate shaft into a striking force in a rotation direction and transmits the striking force to the tool bit, an impact sleeve, a ball, a hammer, a cylinder, a gear which does not convert the rotational force of the intermediate shaft into the striking force in the rotation direction, a sleeve, a cylinder, a motion conversion mechanism for converting the rotational force of the intermediate shaft into a striking force in a linear motion direction and transmits the striking force to the tool bit, a piston, a striker, an intermediate member, a clutch for switching the transmission paths of the rotational force of the intermediate shaft and a slide gear.

### TECHNICAL FIELD The present invention relates to a power tool that transmits a rotational force of a rotary member to a tool bit to machine a target object.

### BACKGROUND ART

Conventionally, a power tool in which a power of a power source is transmitted to a tool bit to rotate or reciprocally move the tool bit, thereby machining a target object has been known, and Patent Document 1 describes one example thereof. A hammer drill, which is the power tool described in the Patent Document 1, has a driving motor serving as a power source, and the power of the driving motor is transmitted to an intermediate shaft by way of a gear mechanism. Moreover, a cylinder that is parallel with the intermediate shaft is provided, and a piston and a striking member are provided so as to be linearly movable inside the cylinder.

Moreover, a motion conversion mechanism for converting the rotational force of the intermediate shaft into a linear motion force of a piston and a clutch mechanism are provided, and the clutch mechanism connects or disconnects a path for transmitting the rotational force of the intermediate shaft to the motion conversion mechanism.

In the hammer drill described in Patent Document 1, when a hammer drill mode is selected, the clutch mechanism connects the path for transmitting the rotational force of the intermediate shaft to the motion conversion mechanism. Therefore, when the rotational force of the intermediate shaft is converted into a linear motion force of the piston and the piston is reciprocally moved, a striking force for striking the striking member is generated. The striking force of the striking member is transmitted to a hammer bit. Specifically, the striking force in a linear motion direction is applied to the hammer bit. Meanwhile, the rotational force of the intermediate shaft is transmitted to the cylinder byway of the gear mechanism, and is further transmitted to the hammer bit through a tool bit holding unit. In other words, the rotational force is transmitted to the hammer bit.

On the other hand, when a drill mode is selected, the clutch mechanism disconnects the path for transmitting the rotational force of the intermediate shaft to the motion conversion mechanism. Consequently, no striking force is applied to the hammer bit, and only the rotational force is transmitted to the hammer bit. Moreover, when a hammer mode is selected, the clutch mechanism connects the path for transmitting the rotational force of the intermediate shaft to the motion conversion mechanism and disconnects the path for transmitting the rotational force of the intermediate shaft to the gear mechanism. Therefore, only the striking force is transmitted to the hammer bit.

### RELATED ART DOCUMENTS

### Patent Documents

Patent Document 1: Japanese Patent Application Laid-Open Publication No. H07-328955

### SUMMARY OF THE INVENTION

### Problems to Be Solved by the Invention

In the power tool described in the above-mentioned Patent Document 1, there are three switchable modes, that is, the hammer drill mode, the drill mode and the hammer mode. However, it is not provided with the so-called impact mode for applying a striking force in a rotation direction.

An object of the present invention is to provide a power tool capable of applying a striking force in a rotation direction to a tool bit.

### Means for Solving the Problems

A power tool according to an embodiment is a power tool, which holds a tool bit and transmits a rotational force of a rotary member to the tool bit, and the power tool is switchable between an impact mode in which the rotational force of the rotary member is transmitted as a striking force in a rotation direction of the tool bit and a hammer mode in which the rotational force of the rotary member is transmitted as a striking force in a linear motion direction of the tool bit without converting the rotational force into a striking force in the rotation direction of the tool bit.

A power tool according to another embodiment is a power tool, which holds a tool bit and transmits a rotational force of a rotary member to the tool bit, and the power tool includes: a first power transmitting mechanism for converting the rotational force of the rotary member into a striking force in a rotation direction and transmitting the striking force to the tool bit; a second power transmitting mechanism for transmitting the rotational force of the rotary member to the tool bit without converting the rotational force into a striking force in the rotation direction; a third power transmitting mechanism for converting the rotational force of the rotary member into a striking force in a linear motion direction and transmitting the striking force to the tool bit without converting the rotational force into the striking force in the rotation direction; and a switching mechanism capable of switching modes between an impact mode in which the rotational force of the rotary member is transmitted to the first power transmitting mechanism and a hammer drill mode in which the rotational force of the rotary member is transmitted to the second power transmitting mechanism and the third power transmitting mechanism.

A power tool according to another embodiment is a power tool, which holds a tool bit and transmits a rotational force of a rotary member to the tool bit, and the power tool includes: a drill mode in which the rotational force of the rotary member is transmitted as a rotational force of the tool bit; a hammer mode in which the rotational force of the rotary member is transmitted as a striking force in a linear motion direction of the tool bit; a hammer drill mode in which the rotational force of the rotary member is transmitted as the rotational force of the tool bit and the striking force in the linear motion direction of the tool bit; and an impact mode in which the rotational force of the rotary member is transmitted as a striking force in a rotation direction of the tool bit.

A power tool according to another embodiment is a power tool, which holds a tool bit and transmits a rotational force of a motor to the tool bit through a rotary member, and the power tool includes:

a plurality of power transmission paths for transmitting the rotational force of the rotary member to the tool bit; and a switching mechanism for switching the plurality of power transmission paths, and the switching mechanism includes two independent switching members which can move coaxially with the rotary member and connect or disconnect the rotary member and the plurality of power transmission paths.

A power tool according to another embodiment is a power tool, which holds a tool bit and transmits a rotational force of a motor to the tool bit through a rotary member, and the power tool includes: at least three power transmission paths for transmitting the rotational force of the rotary member to the tool bit; and a switching mechanism which is provided coaxially with the rotary member and connects or disconnects the rotary member and the three power transmission paths.

A power tool according to another embodiment is a power tool, which holds a tool bit and transmits a rotational force of a rotary member to the tool bit, and the power tool includes: a plurality of power transmission paths for transmitting the rotational force of the rotary member to the tool bit; and a switching mechanism which connects or disconnects the rotary member and the plurality of the power transmission paths, and the switching mechanism includes: a moving member which is rotatably attached to the rotary member and can move along a center line of the rotary member; a clutch which is rotated integrally with the rotary member and is connected to or disconnected from the moving member when moved along the center line; and an operation member which is operated by an operation of a worker and moves at least one of the moving member and the clutch along the center line.

### Effects of the Invention

According to the present invention, it is possible to apply a striking force in a rotation direction to a tool bit. Moreover, it is possible to select from which power transmission paths the rotational force is transmitted, and consequently the working applicability can be widened.

According to the present invention, it is possible to apply a rotational force or a striking force in a linear motion direction to a tool bit without applying a striking force in a rotation direction to the tool bit. Moreover, it is possible to select from which power transmission paths among three power transmission paths the rotational force of the rotary member is transmitted to the tool bit, and consequently the working applicability can be widened.

### BRIEF DESCRIPTIONS OF THE DRAWINGS

FIG. 1 is a partial cross-sectional view showing the case where a hammer drill mode is selected in a power tool according to the present invention;

FIG. 2 is a partial cross-sectional view showing the case where an impact mode is selected in the power tool according to the present invention;

FIG. 3 is a partial cross-sectional view showing the case where a drill mode is selected in the power tool according to the present invention;

FIG. 4 is a partial cross-sectional view showing the case where a neutral mode is selected in the power tool according to the present invention;

FIG. 5 is a partial cross-sectional view showing the case where a hammer mode is selected in the power tool according to the present invention;

FIG. 6 is a perspective view showing a principal part in the case where the hammer drill mode is selected in the power tool according to the present invention;

FIG. 7 is a perspective view showing a principal part in the case where the impact mode is selected in the power tool according to the present invention;

FIG. 8 is a perspective view showing a principal part in the case where the drill mode is selected in the power tool according to the present invention;

FIG. 9 is a perspective view showing a principal part in the case where the hammer mode is selected in the power tool according to the present invention;

FIG. 10 is a plan view showing a principal part in the case where the hammer drill mode is selected in the power tool according to the present invention;

FIG. 11 is a plan view showing a principal part in the case where the impact mode is selected in the power tool according to the present invention;

FIG. 12 is a plan view showing a principal part in the case where the drill mode is selected in the power tool according to the present invention;

FIG. 13 is a plan view showing a principal part in the case where the neutral mode is selected in the power tool according to the present invention;

FIG. 14 is a plan view showing a principal part in the case where the hammer mode is selected in the power tool according to the present invention; and

FIG. 15(A) is a front view showing a lever used in the power tool according to the present invention and FIG. 15(B) is a bottom view showing the lever of FIG. 15(A).

### DETAILED DESCRIPTION OF PREFERRED EMBODIMENTS

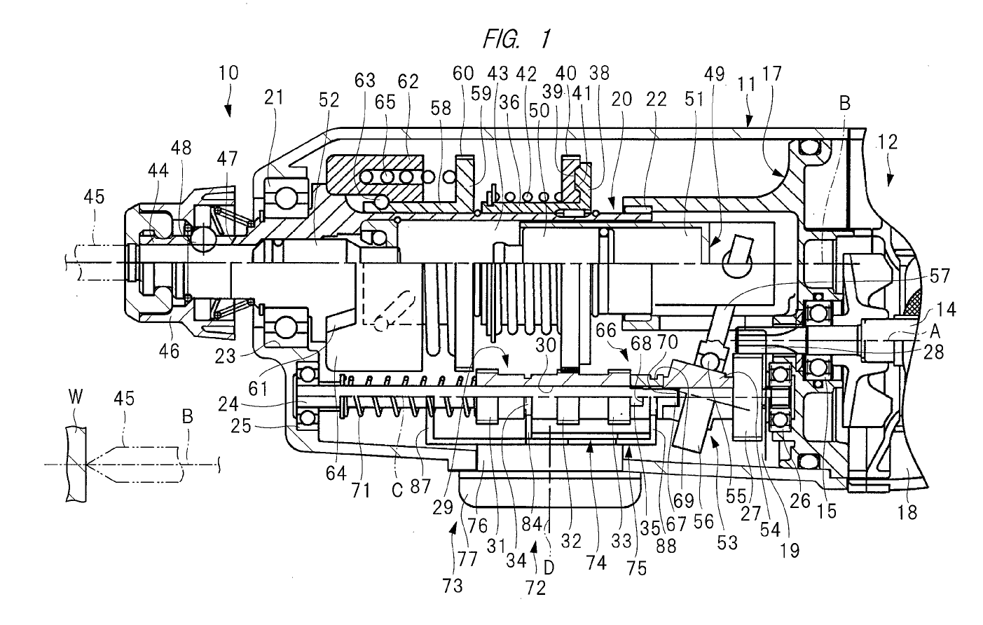

Hereinafter, one embodiment of the present invention will be described in detail with reference to the drawings. A power tool 10 shown in FIGS. 1 to 5 has a tool main body 11, and a power motor 12 is provided in the tool main body 11. A trigger switch is provided in the tool main body 11, and when a worker operates the trigger switch, power is supplied to the power motor 12, so that a rotary shaft 14 of the power motor 12 is rotated. The rotary shaft 14 is rotatably supported by a bearing 15, and a gear 28 is formed on an outer circumferential surface of the rotary shaft 14. An inner casing 17 is attached to the inside of the tool main body 11, and the inner casing 17 partitions the inside of the tool main body 11 into a first housing room 18 and a second housing room 19. The power motor 12 is disposed in the first housing room 18. From the inside of the second housing room 19 toward the outside of the tool main body 11, a cylinder 20 having a tube shape is provided.

The cylinder 20 is rotatably supported by two bearings 21 and 22. The bearing 22 is provided between the inner casing 17 and the outer circumferential surface of the cylinder 20. The bearing 21 is provided between an inner circumferential surface of a shaft hole 23 of the tool main body 11 and the outer circumferential surface of the cylinder 20. A center line A around which the rotary shaft 14 is rotated and a center line B around which the cylinder 20 is rotated are mutually parallel with each other.

An intermediate shaft 24 for transmitting the power of the power motor 12 to the cylinder 20 is provided. The intermediate shaft 24 corresponds to a rotary member of the present invention. The intermediate shaft 24 is disposed in the second housing room 19, and the intermediate shaft 24 is rotatably supported by two bearings 25 and 26. The bearing 26 is supported by the inner casing 17, and the bearing 25 is supported by the tool main body 11. A center line C around which the intermediate shaft 24 is rotated is parallel with the two center lines A and B, and the intermediate shaft 24 does not move in a direction along the center line C.

On the outer circumferential surface of the intermediate shaft 24, a gear 27 is fixed next to the bearing 26 in a direction along the center line C. The gear 27 is rotated integrally with the intermediate shaft 24, and the gear 27 is meshed with a gear 28. The number of teeth of the gear 27 is larger than the number of teeth of the gear 28, so that the gears 27 and 28 serve as a reducer for reducing the rotation speed of the intermediate shaft 24 relative to the rotation speed of the rotary shaft 14 when transmitting the rotational force of the rotary shaft 14 to the intermediate shaft 24.

On the other hand, a slide gear 29 as a tube member is provided in the second housing room 19 and the intermediate shaft 24 is disposed in a shaft hole 30 of the slide gear 29. The slide gear 29 is provided between the bearing 25 and the gear 27 in a direction along the center line C. The slide gear 29 can move in a direction along the center line C with respect to the intermediate shaft 24, and the slide gear 29 is rotatable around the center line C with respect to the intermediate shaft 24. The slide gear 29 can move coaxially with the intermediate shaft 24.

On the outer circumferential surface of the slide gear 29, a first gear 31, a second gear 32 and a third gear 33 are formed as a plurality of driving gears. The first gear 31, the second gear 32 and the third gear 33 are provided at mutually different positions in the direction along the center line C. The second gear 32 is provided between the first gear 31 and the third gear 33 in the direction along the center line C. The third gear 33 is provided between the gear 27 and the second gear 32 in the direction along the center line C. Moreover, on the outer circumferential surface of the slide gear 29, a concave part 34 is formed between the first gear 31 and the second gear 32 in the direction along the center line C. Furthermore, on the slide gear 29, at the end part close to the gear 27 in the direction along the center line C, a meshing part 35 is formed. The meshing part 35 has concave and convex portions in the direction along the center line C.

On the outer circumferential surface of the cylinder 20, at a position closer to the bearing 22 relative to the bearing 21 in a direction along the center line B, a cylinder-shaped sleeve 36 is attached. The cylinder 20 is provided in a shaft hole of the sleeve 36. The sleeve 36 is provided so as to be rotated integrally with the cylinder 20, and the sleeve 36 does not move in the direction along the center line B of the cylinder 20. At the end part of the sleeve 36 in the direction along the center line B, an outward flange 38 is provided. Of the side surfaces of the outward flange 38, on the side surface on the side opposite to the bearing 22, a meshing part 39 is formed. The meshing part 39 has concave and convex portions in the direction along the center line B.

Moreover, on the outer circumferential surface of the sleeve 36, a gear 40 serving as a second driven gear is attached. The gear 40 has an annular shape and can rotate with respect to the sleeve 36. Also, the gear 40 can move in the direction along the center line B with respect to the sleeve 36 and is selectively meshed with the second gear 32 or the third gear 33.

On the side surface of the gear 40 that is closer to the outward flange 38, a meshing part 41 is formed. The meshing part 41 has concave and convex portions in the direction along the center line B. Moreover, an elastic member 42 is attached to the outer circumferential surface of the sleeve 36, and the gear 40 is pressed toward the outward flange 38 by a force of the elastic member 42. A compression coil spring may be used as the elastic member 42. The cylinder 20, the sleeve 36 and the gear 40 correspond to a second power transmission mechanism of the present invention.

Thus, when the gear 40 is pressed by the force of the elastic member 42 and the meshing part 41 is meshed with the meshing part 39, power can be transmitted between the sleeve 36 and the gear 40. In contrast, when the gear 40 is moved in a direction away from the outward flange 38 against the force of the elastic member 42 and the meshing part 41 and the meshing part 39 are separated from each other, power is no longer transmitted between the sleeve 36 and the gear 40.

Meanwhile, a shaft hole 43 centered on the center line B is formed in the cylinder 20, and a tool bit holding unit 44 is formed at a position on the outer part of the tool main body 11 in a longitudinal direction of the cylinder 20. The tool bit holding unit 44 has a cylindrical shape, and the shaft hole 43 reaches the tool bit holding unit 44. A tool bit 45 can be attached to or detached from the shaft hole 43 of the tool bit holding unit 44. An end cover 46 is attached to the outer circumference of the tool bit holding unit 44, and a holding hole 47 that penetrates the tool bit holding unit 44 in a radial direction is formed therein. A ball 48 is held in the holding hole 47.

A groove extending in the direction along the center line B is formed on the tool bit 45, and when apart of the ball 48 is placed in the groove, the rotational force of the cylinder 20 is transmitted to the tool bit 45 by an engaging force between the ball 48 and the tool bit 45. Moreover, the tool bit 45 can move in the direction along the center line B with respect to the tool bit holding unit 44 within the range of the groove length. The end cover 46 has the cylindrical shape, and it restricts the ball 48 from going out of the groove. When the ball 48 is released out of the groove of the tool bit 45 by operating the end cover 46, the tool bit 45 can be removed from the shaft hole 43 of the tool bit holding unit 44.

Next, a mechanism which applies a striking force in a linear motion direction to the tool bit 45 held by the tool bit holding unit 44 will be described. The striking force in the linear motion direction is a striking force in the direction along the centerline B. A piston 49 is provided in the shaft hole 43 of the cylinder 20. The piston 49 can reciprocally move in the direction along the center line B. The piston 49 has a cylindrical shape and a striker 50 is provided inside the piston 49. The piston 49 and the striker 50 are provided coaxially with the tool bit 45. The striker 50 is linearly movable in the direction along the center line B with respect to the piston 49. Moreover, inside the piston 49, a pneumatic chamber 51 is formed between the piston 49 and the striker 50. Further, inside the shaft hole 43, an intermediate member 52 is formed between the tool bit 45 and the striker 50. The intermediate member 52 is linearly movable in the direction along the center line B within a predetermined range. The piston 49, the striker 50 and the intermediate member 52 mentioned above correspond to a mechanism for applying the striking force in the linear motion direction to the tool bit 45.

Moreover, a motion conversion mechanism 53 for converting the rotational force of the intermediate shaft 24 into a linear motion force of the piston 49 is provided in the second housing room 19. The motion conversion mechanism 53 is provided with an inner ring 54 attached to the intermediate shaft 24 and an outer ring 56 provided with interposing a rolling element 55 between itself and the inner ring 54. A coupling rod 57 is coupled to the outer ring 56, and the coupling rod 57 is coupled to the piston 49. The inner ring 54 is rotatably attached to the intermediate shaft 24, and the inner ring 54 does not move in the direction along the center line C of the intermediate shaft 24. The motion conversion mechanism 53, the piston 49, the striker 50, the intermediate member 52 and others mentioned above correspond to a third power transmission mechanism of the present invention.

Furthermore, a first power transmission mechanism that transmits the rotational force of the intermediate shaft 24 to the cylinder 20 and applies a striking force in a rotation direction will be described. On an outer circumferential surface of the cylinder 20, an impact sleeve 58 is attached between the bearing 21 and the sleeve 36. The impact sleeve 58 is relatively rotatable with respect to the cylinder 20, and the impact sleeve 58 does not move in the direction along the center line B with respect to the cylinder 20. An outward flange 59 is provided to the impact sleeve 58, and a gear 60 serving as a first driven gear is formed on the outer circumferential surface of the outward flange 59.

On the outer circumferential surface of the cylinder 20, a meshing part 61 is provided between the impact sleeve 58 and the bearing 21 in the direction along the center line B. Moreover, on the outer circumference of the impact sleeve 58, a hammer 62 is attached. The hammer 62 has an annular shape and a groove is formed on an inner circumferential surface of the hammer 62, and a groove is formed on an outer circumferential surface of the hammer 62 and the ball 63 is held between the mutual grooves. The impact sleeve 58 and the hammer 62 are connected to each other by an engaging force of the ball 63 so as to be able to transmit the power. The hammer 62 can move with respect to the impact sleeve 58 in the direction along the center line B within a predetermined range and is rotatable. A meshing part 64 is provided on the hammer 62.

Moreover, an elastic member 65 is provided between the outward flange 59 and the hammer 62. The elastic member 65 generates a force in a direction of moving the hammer 62 away from the outward flange 59, that is, in a direction of pressing it onto the bearing 21. A compression coil spring may be used as the elastic member 65. When the hammer 62 is moved in the direction along the center line B, the meshing part 64 is reciprocally meshed with and released from the meshing part 61. The gear 60, the impact sleeve 58, the ball 63, the hammer 62, the meshing part 61, the elastic member 65 and others mentioned above correspond to the first power transmission mechanism for transmitting the rotational force of the intermediate shaft 24 to the cylinder 20 and applying a striking force in a rotation direction.

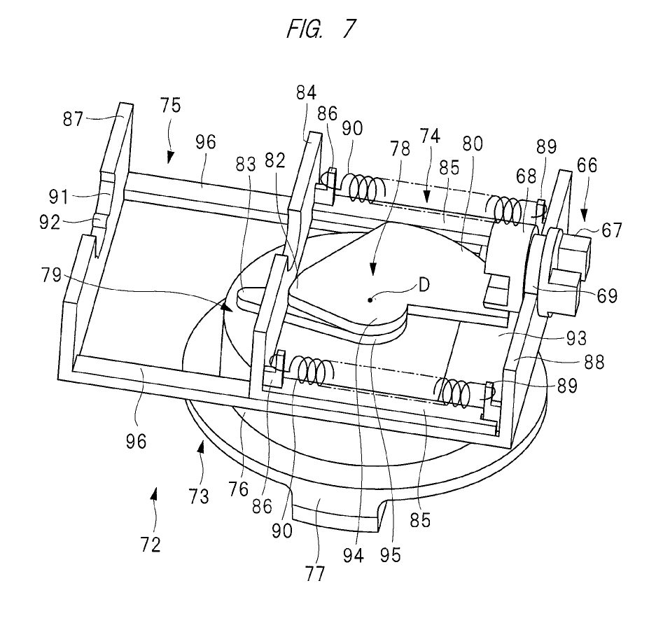

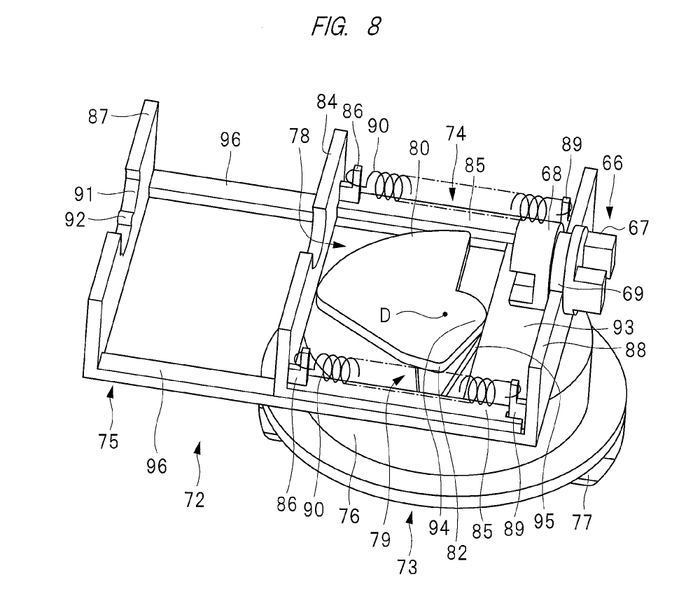

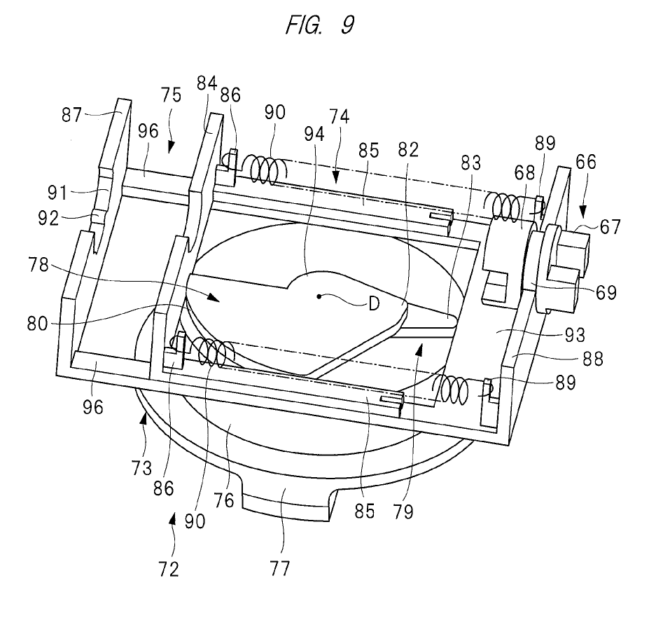

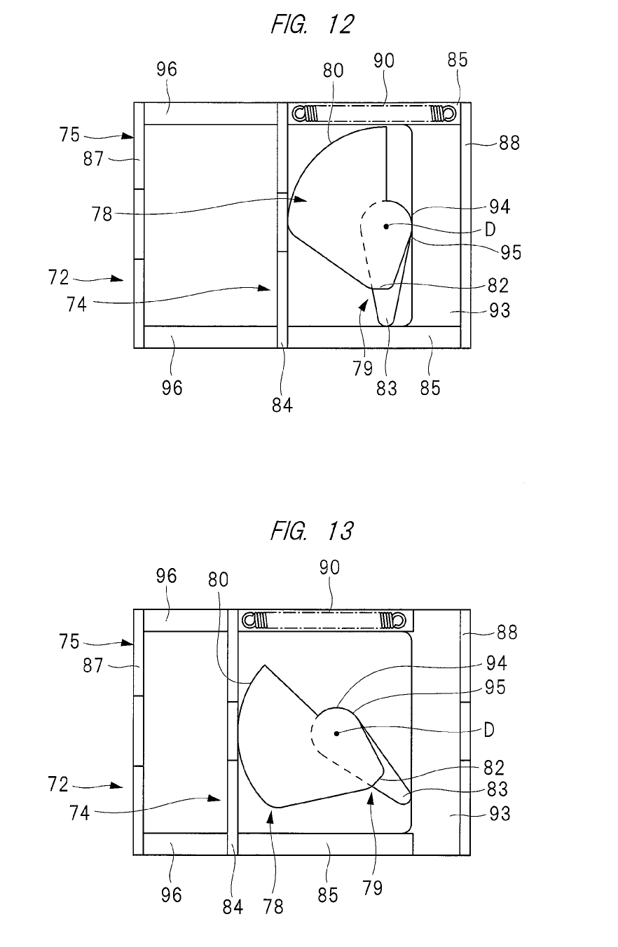

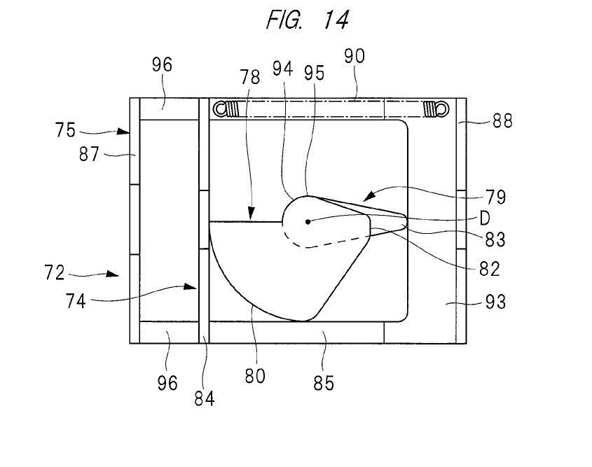

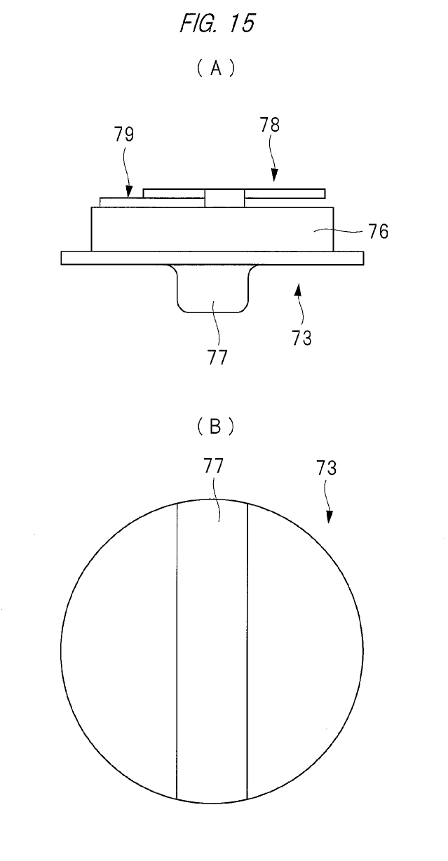

Next, a configuration of a switching mechanism of the present invention will be described with reference to FIGS. 1 to 15. On the outer circumference of the intermediate shaft 24, a clutch 66 is attached. The clutch 66 has an annular shape, and the clutch 66 is spline-connected to the intermediate shaft 24. For this reason, the clutch 66 is rotated integrally with the intermediate shaft 24, and can move in the direction along the center line C with respect to the intermediate shaft 24. The clutch 66 can move coaxially with the intermediate shaft 24. Moreover, the clutch 66 and the slide gear 29 can move independently from each other. Namely, the clutch 66 can come closer to or move away from the slide gear 29. The clutch 66 is provided between the inner ring 54 and the slide gear 29 in the direction along the center line C. On the clutch 66, a meshing part 67 is provided at a position close to the inner ring 54 and a meshing part 68 is provided at a position close to the slide gear 29. Moreover, a concave part 69 is formed on the outer circumference of the clutch 66. The concave part 69 is a groove formed on the entire circumference of the clutch 66.

A meshing part 70 is provided on the inner ring 54, and when the clutch 66 is moved in the direction along the center line C, the meshing part 67 and the meshing part 70 can be meshed with each other, or the meshed state between the meshing part 67 and the meshing part 70 can be released from each other. Moreover, when the clutch 66 and the slide gear 29 are positioned in the direction along the center line C, the meshing part 68 and the meshing part 35 can be meshed with each other, or the meshed state between the meshing part 68 and the meshing part 35 can be released from each other. The meshed state between the meshing part 67 and the meshing part 70 or the meshed state between the meshing part 68 and the meshing part 35 is referred to as an engagement of the clutch 66. On the other hand, the release from the meshed state between the meshing part 67 and the meshing part 70 or the release from the meshed state between the meshing part 68 and the meshing part 35 is referred to as a release of the clutch 66.

On the outer circumference of the intermediate shaft 24, an elastic member 71 which generates a force for moving the slide gear 29 in the direction along the center line C is attached. The elastic member 71 is disposed between the bearing 25 and the slide gear 29 and the elastic member 71 generates a force for pressing the slide gear 29 toward the clutch 66. A compression coil spring may be used as the elastic member 71. The clutch 66, the slide gear 29, the first gear 31 to the third gear 33 and others mentioned above correspond to a switching mechanism of the present invention.

Moreover, an adjusting mechanism 72 that moves the clutch 66 and the slide gear 29 in the direction along the center line C and stops them at desired positions in the direction along the center line C will be described. The adjusting mechanism 72 is provided with a lever 73, a first slide member 74 and a second slide member 75. The lever 73 is attached to the tool main body 11 so as to be rotatable around an axis line D. The lever 73 is provided with a column part 76 and a knob part 77 formed integrally with the column part 76, and the knob part 77 is disposed outside the tool main body 11. Within the plane including the center line C and the axis line D, the center line C and the axis line D form a right angle. The axis line D is disposed between the gear 40 and the gear 60 in the direction along the center line C.

Moreover, a first cam member 78 and a second cam member 79 fixed to the column part 76 of the lever 73 are provided. When the worker operates the lever 73, the lever 73, the first cam member 78 and the second cam member 79 are integrally rotated around the axis line D. The first cam. member 78 has a plate shape, and a first contact part 80 to a third contact part 94 are provided as a first cam surface of the present invention on the outer circumferential surface of the first cam member 78. The first contact part 80 to the third contact part 94 are formed continuously as smooth curved surfaces.

When the first cam. member 78 is seen in a plan view, the first contact part 80 is formed within a range of 90 degrees on the circumference centered on the axis line D. The second contact part 82 has a distance from the axis line D shorter than that of the first contact part 80, and the second contact part 82 is located at a position different from the first contact part 80 on the circumference centered on the axis line D. Moreover, the third contact part 94 has a distance from the axis line D shorter than that of the second contact part 82, and the third contact part 94 is located at a position forming 90 degrees with respect to the second contact part 82 on the circumference centered on the axis line D. When the first cam member 78 is seen in a plan view, the first contact part 80 to third contact part 94 are displaced in the direction along the center line C.

Also, the second cam. member 79 is rotated integrally with the first cam member 78, and on the outer circumferential surface of the second cam member 79, a first contact part 83 and a second contact part 95 are formed as a second cam surface of the present invention. The first contact part 83 has the same distance from the axis line D as that of the first contact part 80. Furthermore, the first contact part 83 is disposed at the same position as that of the second contact part 82 on the circumference centered on the axis line D. The distance from the second contact part 95 to the axis line D is the same as the distance from the third contact part 94 to the axis line D. When the second cam member 79 is seen in a plan view, the first contact part 83 and the second contact part 95 are displaced in the direction along the center line C.

The first slide member 74 and the second slide member 75 are provided between the slide gear 29 and the lever 73 in the direction along the axis line D. Moreover, the first slide member 74 and the second slide member 75 are linearly movable in the direction along the center line C along with the operation of the lever 73. Note that a guide member for supporting the first slide member 74 and the second slide member 75 so as to be linearly movable is provided in the second housing room 19. Both of the first slide member 74 and the second slide member 75 are disposed in the second housing room 19.

The first slide member 74 is provided with a locking plate 84 and arm parts 85 continuously formed at the two ends of the locking plate 84. The arm parts 85 extend in the direction along the center line C. The locking plate 84 is inserted into the concave part 34 of the slide gear 29, and when the first slide member 74 moves in the direction along the center line C, the slide gear 29 moves in the direction along the center line C. Moreover, a pin 86 is formed on the first slide member 74.

The second slide member 75 is provided with two locking plates 87 and 88 disposed with a gap in the direction along the center line C, an arm part 96 that connects the locking plates 87 and 88 with each other, and a projecting part 93 that protrudes toward the locking plate 87 from the end of the locking plate 88. The two locking plates 87 and 88 are parallel with each other, and the two locking plates 87 and 88 are disposed with a gap larger the length of the slide gear 29 in the direction along the center line C. Moreover, the first slide member 74 is disposed between the two locking plates 87 and 88.

Of the two locking plates 87 and 88, the locking plate 88 that is closer to the inner ring 54 is provided with a pin 89, and two ends of a tension spring 90 are attached to the pins 86 and 89. The tension spring 90 generates a force for bringing the locking plate 84 and the locking plate 88 closer to each other. Of the two locking plates 87 and 88, the end of the locking plate 88 closer to the inner ring 54 is disposed in the concave part 69 of the clutch 66.

Also, of the two locking plates 87 and 88, a half-moon shaped notch part 91 is formed on the locking plate 87 closer to the bearing 25, and a protrusion 92 is provided on the inner circumferential surface of the notch part 91. Moreover, the arm part 85 of the first slide member 74 extends from the locking plate 84 toward the locking plate 88 of the second slide member 75. By the operation of the lever 73, the outer circumferential surface of the first cam member 78 comes in contact with a side surface of the locking plate 84, and the outer circumferential surface of the second cam member 79 comes in contact with the projecting part 93.

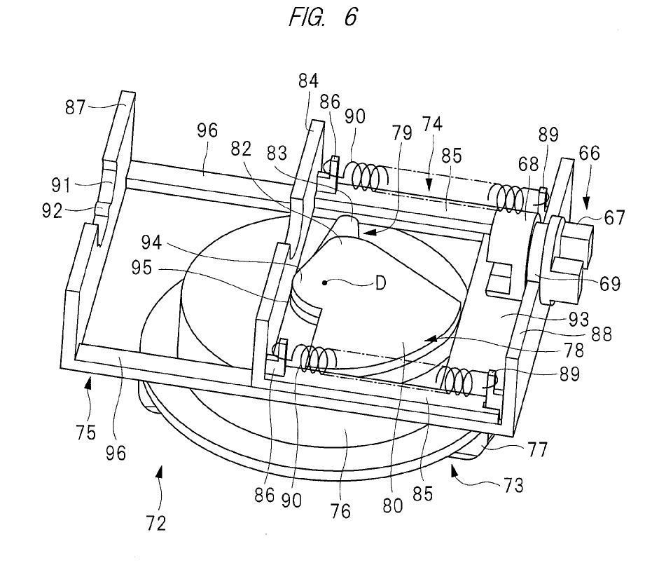

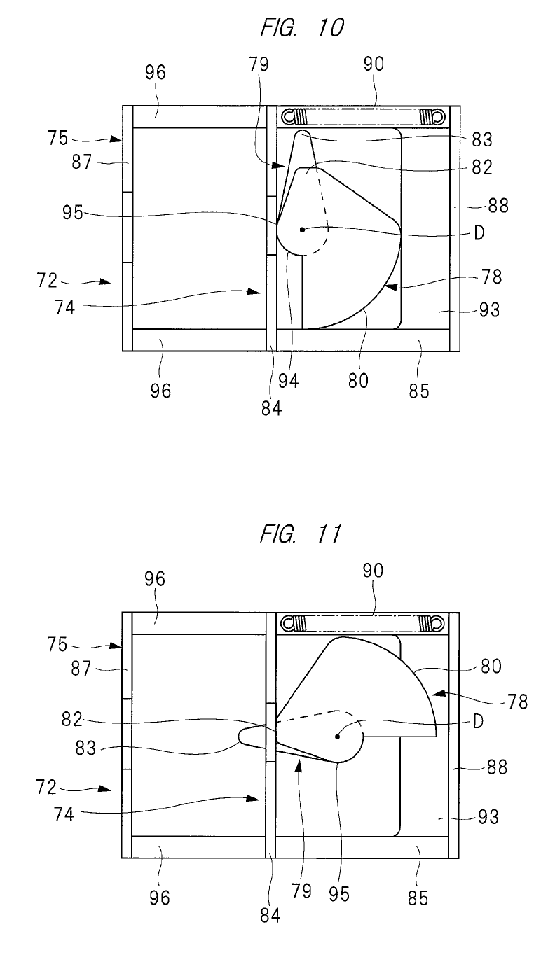

Next, the action of the power tool 10 will be described. In pressing the tool bit 45 onto a target object W, the center line B may be a vertical direction, a horizontal direction or another direction. When the trigger switch is operated and the rotary shaft 14 of the power motor 12 is rotated, the rotational force of the rotary shaft 14 is transmitted to the intermediate shaft 24 by way of the gears 28 and 27. When the lever 73 is operated and a hammer drill mode that is a first mode is selected, the third contact part 94 of the first cam member 78 comes in contact with the locking plate 84 as shown in FIG. 6 and FIG. 10, and the second cam member 79 is not in contact with the projecting part 93. Furthermore, the force of the elastic member 71 is transmitted to the clutch 66 through the slide gear 29, so that the clutch 66 is engaged with the inner ring 54 as shown in FIG. 1.

Moreover, the amount of movement of the first slide member 74 in the direction approaching to the bearing 25 against the force of the tension spring 90 is determined by a distance from the axis line D to the first contact part 83. More specifically, the distance between the locking plate 88 and the locking plate 84 in the direction along the center line C is shortest within a range that can be set in the present embodiment. Namely, the distance between the locking plate 88 and the locking plate 84 is equivalent to the length of the arm part 85. For this reason, the clutch 66 is engaged also with the slide gear 29. When the slide gear 29 is positioned in the direction along the center line C, the second gear 32 is meshed with the gear 40, and the first gear 31 and the third gear 33 are not meshed with any gears.

Moreover, the rotational force of the intermediate shaft 24 is transmitted to the cylinder 20 by way of the clutch 66, the slide gear 29, the second gear 32, the gear 40 and the sleeve 36. The rotational force of the cylinder 20 is transmitted to the tool bit 45, and the target object W is processed. If the rotation of the tool bit 45 is not hindered, the engagement between the meshing part 39 and the meshing part 41 is maintained, and the power is transmitted between the gear 40 and the sleeve 36 through a frictional force.

In the case where the rotation of the tool bit 45 is hindered for the reason that the tool bit 45 bites into the target object W or the like, the gear 40 moves in a direction away from the outward flange 38 against the force of the elastic member 42, so that the engagement between the meshing part 39 and the meshing part 41 is released. More specifically, the gear 40 rotates but the sleeve 36 is locked. As a result, the gear 40 and the sleeve 36 rotate relatively with each other, so that the power of the gear 40 is no longer transmitted to the sleeve 36. In other words, the meshing part 39 and the meshing part 41 function as a torque limiter. Therefore, it is possible to prevent the tool bit 45 from biting into the target object W more than required.

Meanwhile, since the clutch 66 is engaged with the inner ring 54, the rotational force of the intermediate shaft 24 is converted into a linear motion force of the piston 49 by the motion conversion mechanism 53. When the piston 49 reciprocally moves inside the cylinder 20, the pneumatic pressure inside the pneumatic pressure chamber 51 is alternately increased and decreased repetitively to generate a striking force, so that the striking force is transmitted to the tool bit 45 by way of the striker 50 and the intermediate member 52. In this manner, in the power tool 10, the rotational force is applied to the tool bit 45 and the striking force in the direction along the center line B is intermittently applied to the tool bit 45. Note that, since the gear 60 is not meshed with any gears, the rotational force of the slide gear 29 is not transmitted to the impact sleeve 58. Therefore, no striking force in the rotation direction is applied to the cylinder 20 from the hammer 62. In this manner, when the hammer drill mode is selected, the path for transmitting the rotational force of the intermediate shaft 24 to the gear 40 and the inner ring 54 is connected, and the path for transmitting the rotational force of the intermediate shaft 24 to the gear 60 is disconnected.

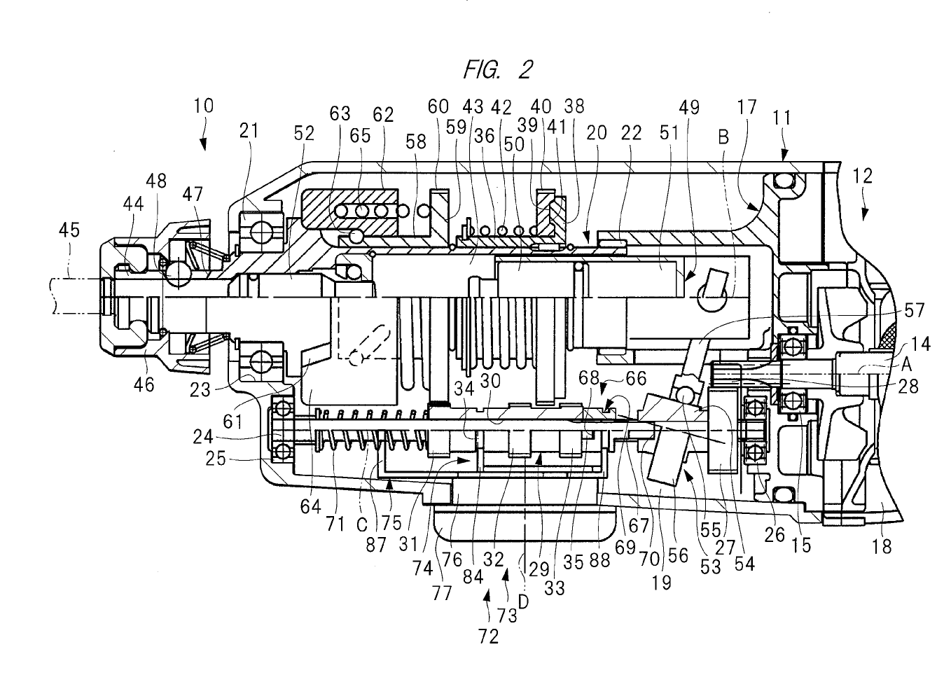

Next, a case in which the lever 73 is operated and an impact mode that is a second mode is selected will be described with reference to FIGS. 2, 7 and 11. When the impact mode is selected, the second contact part 82 of the first cam member 78 comes in contact with the locking plate 84 of the first slide member 74. Also, the second cam member 79 is not in contact with the projecting part 93. Since the second contact part 82 of the first cam member 78 comes in contact with the locking plate 84 of the first slide member 74, the first slide member 74 stops at a position further apart from the inner ring 54 in comparison with the case where the hammer drill mode is selected.

Moreover, in comparison with the case where the hammer drill mode is selected, the second slide member 75 stops at a position further apart from the inner ring 54 by the force of the tension spring 90. More specifically, the distance between the locking plate 88 and the locking plate 84 in the direction along the center line C is equivalent to the length of the arm part 85, and the first slide member 74 and the second slide member 75 are located at positions further apart from the inner ring 54 in comparison with the case where the hammer drill mode is selected.

By the above-mentioned actions, the clutch 66 is meshed with the slide gear 29 and released from the inner ring 54. Then, the first gear 31 is meshed with the gear 60, and the second gear 32 and the third gear 33 are not meshed with any gears. For this reason, the rotational force of the intermediate shaft 24 is transmitted to the impact sleeve 58 by way of the first gear 31 and the gear 60. The rotational force of the impact sleeve 58 is transmitted to the cylinder 20 by way of the ball 63 and the hammer 62, so that the target object W is processed by the tool bit 45. In the case where a load applied to the tool bit 45 is a predetermined value or less, the engagement between the meshing part 61 and the meshing part 64 is maintained, and the rotational force of the hammer 62 is transmitted to the cylinder 20.

On the other hand, when the load applied to the tool bit 45 exceeds the predetermined value, the number of rotations of the cylinder 20 is decreased, a repulsion force increases at the engagement part between the meshing part 61 and the meshing part 64, and the ball 63 rolls along the groove, so that the impact sleeve 58 and the hammer 62 are relatively rotated within a predetermined angle and the hammer 62 moves in a direction approaching to the outward flange 59. Thus, the engagement between the meshing part 61 and the meshing part 64 is released and the rotational force of the hammer 62 is no longer transmitted to the cylinder 20.

Moreover, when the rotation of the hammer 62 is continued and the meshing part 64 gets over the meshing part 61, the pressing force to be applied to the hammer 62 by the elastic member 65 becomes larger than a force in the direction of bringing the hammer 62 close to the outward flange 59 and the ball 63 rolls along the groove, so that the hammer 62 is moved in the direction along the center line B, while the hammer 62 and the impact sleeve 58 are rotating relative to each other, and the meshing part 61 and the meshing part 64 are meshed with each other. As a result, the rotational force of the hammer 62 is abruptly transmitted to the cylinder 20. Namely, a striking force in the rotation direction is applied to the cylinder 20.

Note that, when the impact mode is selected, since the gear 40 is not meshed with any gears, the rotational force of the slide gear 29 is not transmitted to the cylinder 20 through the gear 40. Moreover, since the clutch 66 is released from the inner ring 54, the rotational force of the intermediate shaft 24 is not transmitted to the motion conversion mechanism 53. More specifically, the striker 50 does not generate a striking force. In this manner, when the impact mode is selected, the path for transmitting the rotational force of the intermediate shaft 24 to the gear 60 is connected, and the path for transmitting the rotational force of the intermediate shaft 24 to the gear 40 and the inner ring 54 is disconnected.

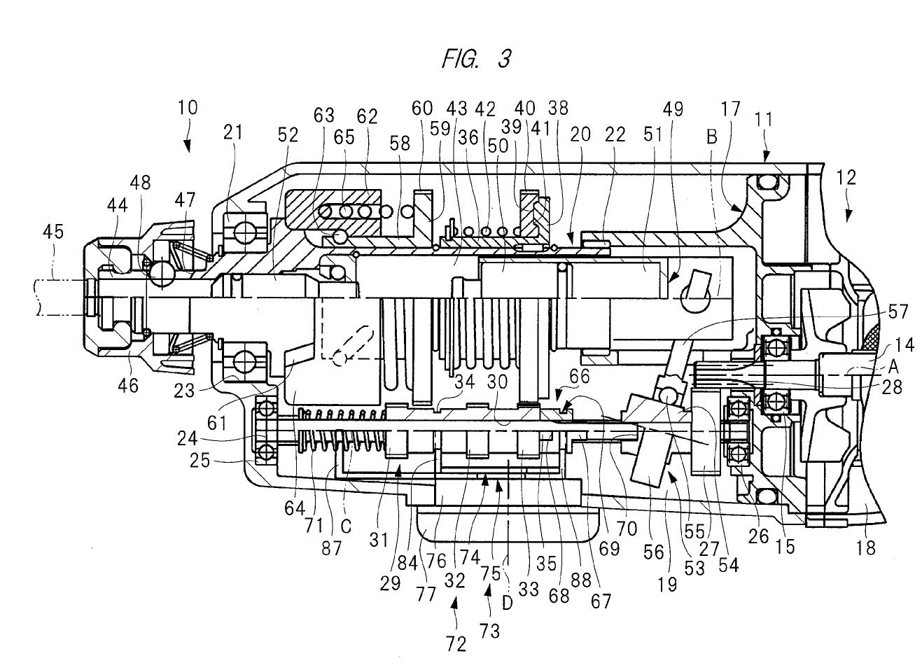

Next, the action in the case where the lever 73 is operated and a drill mode that is a third mode is selected will be described with reference to FIGS. 3, 8 and 12. When the drill mode is selected, the first contact part 80 of the first cam member 78 comes in contact with the locking plate 84. Moreover, the second contact part 95 of the second cam member 79 comes in contact with the projecting part 93. When the first contact part 80 comes in contact with the locking plate 84, the slide gear 29 stops at a position closer to the bearing 25 in comparison with the case in which the impact mode is selected. Moreover, the second slide member 75 moves in a direction approaching to the bearing 25 together with the slide gear 29 by the force of the extension spring 90, and the second slide member 75 stops when the projecting part 93 comes in contact with the second contact part 95. More specifically, the distance between the locking plate 88 and the locking plate 84 in the direction along the center line C is equivalent to the length of the arm part 85, and the first slide member 74 and the second slide member 75 are located at positions further apart from the inner ring 54 in comparison with the case where the impact mode is selected.

Therefore, the third gear 33 is meshed with the gear 40, and the first gear 31 and the second gear 32 are not meshed with any gears. Moreover, the clutch 66 is meshed with the slide gear 29, and the clutch 66 is released from the inner ring 54. Thus, the rotational force of the intermediate shaft 24 is transmitted to the gear 40 by way of the clutch 66, the slide gear 29 and the third gear 33, and the rotational force of the gear 40 is transmitted to the tool bit 45 in the same manner as described above. Note that, since the clutch 66 is not meshed with the inner ring 54, the rotational force of the intermediate shaft 24 is not converted into the linear motion force of the piston 49. Moreover, since the gear 60 is not meshed with any gears, the rotational force of the intermediate shaft 24 is not transmitted to the cylinder 20 through the gear 60. In this manner, when the drill mode is selected, the path for transmitting the rotational force of the intermediate shaft 24 to the gear 40 is connected, and the path for transmitting the rotational force of the intermediate shaft 24 to the gear 60 and the inner ring 54 is disconnected.

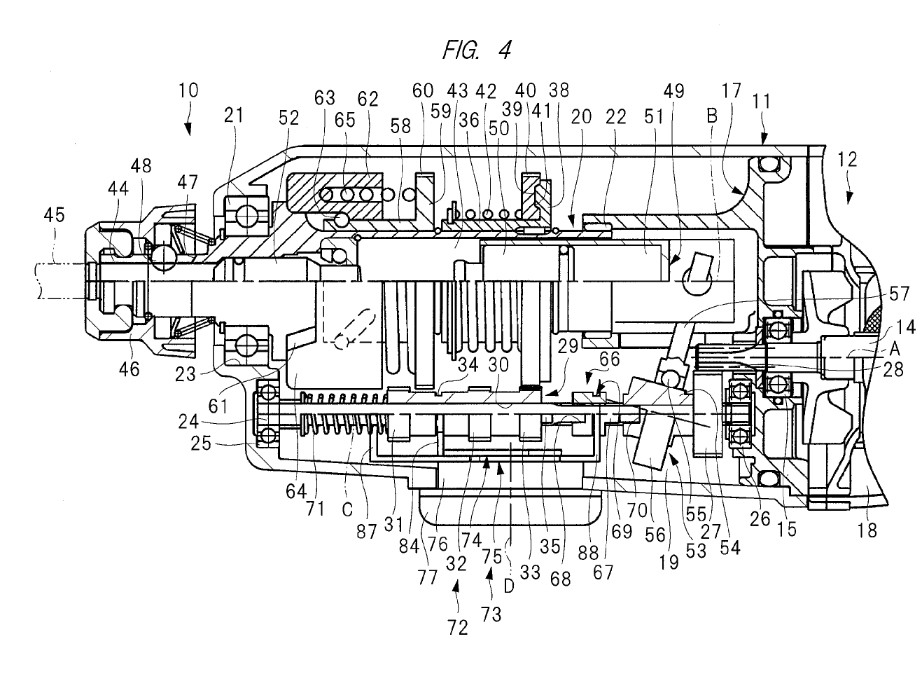

Next, the action in the case where the lever 73 is operated and a neutral mode that is a fourth mode is selected will be described with reference to FIGS. 4 and 13. When the neutral mode is selected, the first contact part 80 of the first cam member 78 comes in contact with the locking plate 84, and the first contact part 83 of the second cam member 79 comes in contact with the projecting part 93. When the second cam member 79 is seen in a plan view, the first contact part 83 is located at a position having 45 degrees with respect to the center line C. Also, the third gear 33 of the slide gear 29 is meshed with the gear 40, and the first gear 31 and the second gear 32 are not meshed with any gears.

On the other hand, the projecting part 93 is in contact with the second cam member 79 and it prevents the distance between the locking plate 84 and the locking plate 88 from being shortened. More specifically, the locking plate 84 and the locking plate 88 are regulated in the direction away from each other by the first and second cam members 78 and 79 (pressed in the direction away from each other), so that the clutch 66 is released from the slide gear 29 and the clutch 66 is not meshed with the inner ring 54. Therefore, the rotational force of the intermediate shaft 24 is not transmitted to the slide gear 29 and the rotational force of the intermediate shaft 24 is not converted into the linear motion force of the piston 49. Therefore, any of the rotational force, the striking force in the linear motion direction and the striking force in the rotation direction is not transmitted to the tool bit 45. In this manner, when the neutral mode is selected, all the paths for transmitting the rotational force of the intermediate shaft 24 to the gears 40 and 60 and the inner ring 54 are disconnected.

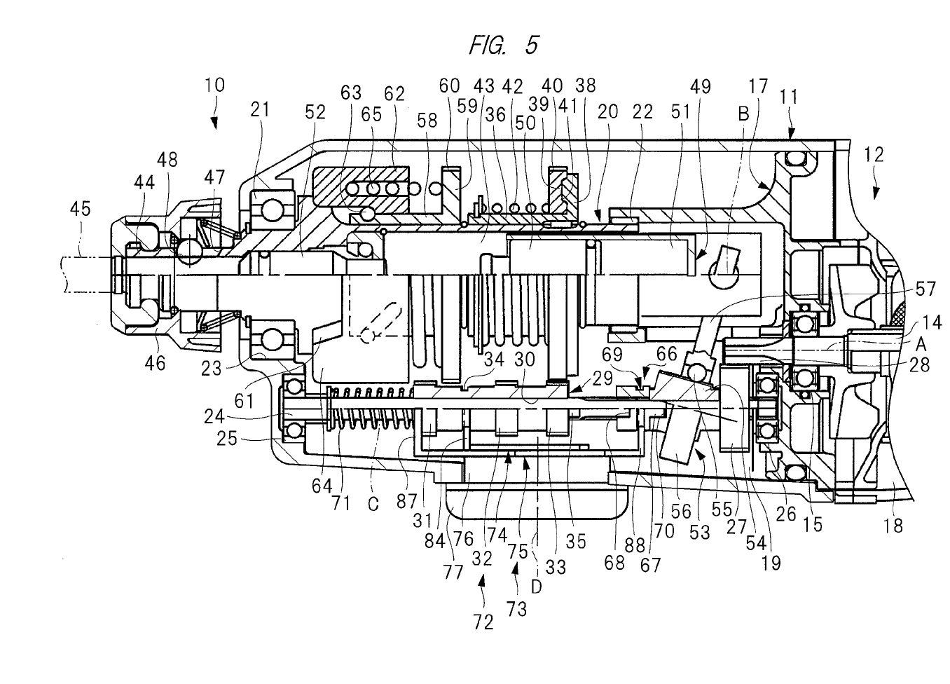

Next, the action in the case where the lever 73 is operated and a hammer mode that is a fifth mode is selected will be described with reference to FIGS. 5, 9 and 14. When the hammer mode is selected, the first contact part 80 of the first cam member 78 comes in contact with the locking plate 84, and the first contact part 83 of the second cam member 79 comes in contact with the projecting part 93. More specifically, the locking plate 84 and the locking plate 88 are located at positions most distant from each other. Therefore, the third gear 33 of the slide gear 29 is meshed with the gear 40, and the first gear 31 and the second gear 32 are not meshed with any gears.

On the other hand, the first contact part 83 is located at a position along the center line C, and the clutch 66 is released from the slide gear 29 and is engaged with the inner ring 54. Therefore, the rotational force of the intermediate shaft 24 is not transmitted to the slide gear 29 and the rotational force of the intermediate shaft 24 is converted into the linear motion force of the piston 49. More specifically, the rotational force and the striking force in the rotation direction are not transmitted to the tool bit 45, and the striking force of the striker 50 is intermittently transmitted to the tool bit 45. Note that, when the hammer mode is selected, the protrusion 92 of the locking plate 87 is meshed with the first gear 31 and the rotation of the slide gear 29 is prevented. In this manner, when the hammer mode is selected, the path for transmitting the rotational force of the intermediate shaft 24 to the inner ring 54 is connected, and the path for transmitting the rotational force of the intermediate shaft 24 to the gears 40 and 60 is disconnected.

As described above, since the power tool 10 can singly select the impact mode in addition to the conventional hammer drill mode, drill mode and hammer mode, it is possible to widen the working range. Moreover, since the neutral mode is further provided, for example, even when a tool bit having a shovel-like part on its tip end to be used for the hammer mode is attached, it is possible to easily adjust the attaching angle thereof.

More specifically, since the power tool 10 of the present invention is provided with five modes, that is, four operation modes and one neutral mode serving as an adjusting mode, it is possible to widen the working range. Moreover, the object of the present invention is to provide the power tool 10 capable of applying a rotational force or a striking force in the linear motion direction to the tool bit 45 without applying a striking force in the rotation direction to the tool bit 45. Furthermore, when the hammer mode is selected, it is possible to apply a striking force in the linear motion direction to the tool bit 45 without applying a striking force in the rotation direction to the tool bit 45. Further, when the drill mode is selected, it is possible to apply a rotational force to the tool bit 45 without applying a striking force in the rotation direction to the tool bit 45.

Moreover, when the impact mode is selected, it is possible to apply the rotational force to the tool bit 45 and apply also the striking force in the rotation direction. On the other hand, when any one of the hammer drill mode, the drill mode and the hammer mode is selected, no striking force in the rotation direction is applied to the tool bit 45. Therefore, by separately using the five kinds of modes (first mode to fifth mode) depending on situations, the load to be applied to the tool bit 45 can be reduced and the working range can be widened.

Furthermore, the layout range of mechanisms such as the clutch 66, the slide gear 29, the intermediate shaft 24, the first slide member 74, the second slide member 75, the first cam member 78, the second cam member 79, the elastic member 71, the first gear 31, the second gear 32, the third gear 33 and others is overlapped with a range from the bearing 21 to the inner casing 17 in the direction along the center line B and is overlapped also with a layout range of the gear 27 in a direction orthogonal to the center line B.

More specifically, by utilizing a space originally present inside the tool main body 11, mechanisms such as the clutch 66, the slide gear 29, the intermediate shaft 24, the first slide member 74, the second slide member 75, the first cam member 78, the second cam member 79, the elastic member 71, the first gear 31, the second gear 32, the third gear 33 and others are disposed. Therefore, it is possible to prevent the power tool 10 from enlarging in a direction along the center line B or in a direction orthogonal to the center line B. Thus, it is possible to prevent the decrease in workability in the case of using the power tool 10 in a narrow space.

Further, by operating the single lever 73, the worker can selectively switch the five kinds of modes easily. Therefore, the workability of the worker can be improved. Moreover, since it is possible to select from which power transmission paths among the first to third power transmission paths the rotational force is transmitted, the working applicability can be widened.

Moreover, the meshing part 61 is integrally formed with an anvil (tool bit holding unit) 44. Therefore, even when the meshing part 61 and the meshing part 64 are repetitively engaged with each other and released from each other, the breakage of the meshing part 61 can be prevented. Also, by operating the single lever 73, the worker can move the slide gear 29 and the clutch 66 in the direction along the center line C. Therefore, the worker can easily switch the respective modes.

The slide gear 29, the clutch 66, the first slide member 74, the second slide member 75, the lever 73, the first cam member 78, the second cam member 79 and others mentioned above correspond to the switching mechanism of the present invention. The slide gear 29 and the clutch 66 correspond to switching members of the present invention. The intermediate shaft 24 corresponds to the rotary member of the present invention. The first gear 31 corresponds to a first transmitting member of the present invention, the second gear 32 corresponds to a second transmitting member of the present invention, and the third gear 33 corresponds to a third transmitting member of the present invention. The gear 60, the impact sleeve 58, the ball 63, the hammer 62, the meshing part 61, the elastic member 65 and others correspond to a first power transmission path of the present invention. The cylinder 20, the sleeve 36 and the gear 40 correspond to a second power transmission path of the present invention. The motion conversion mechanism 53, the piston 49, the striker 50, the intermediate member 52 and others correspond to a third power transmission path of the present invention. More specifically, the power tool 10 is provided with a plurality of power transmission paths. The lever 73, the first cam member 78 and the second cam member 79 correspond to an operation member of the present invention. The slide gear 29 corresponds to a first moving member of the present invention, and the clutch 66 corresponds to a second moving member of the present invention. The power motor 12 corresponds to a motor of the present invention.

It is needless to say that the present invention is not limited to the above-mentioned embodiment and various modifications can be made within a scope of the gist of the present invention. For example, the tool bit may be a driver bit for fastening a screw member other than the bits for carrying out machining processes such as a crushing process, a chipping process, a boring process and others. Also, the center line of the rotation shaft of the power motor may be parallel with the center lines of the cylinder and the intermediate shaft, or may intersect therewith. Moreover, the rotary member of the present invention is a rotary element through which a rotational force of an electric motor serving as a power source, that is, a torque is transmitted, and the rotary member of the present invention includes a rotary shaft, a gear, a pulley, a sprocket, a carrier for a planetary gear mechanism, and the like. Furthermore, the mode may be switched by moving the intermediate shaft in an axis direction.

### DESCRIPTION OF REFERENCE CHARACTERS

10 . . . power tool, 20 . . . cylinder, 24 . . . intermediate shaft, 29 . . . slide gear, 31 . . . first gear, 32 . . . second gear, 33 . . . third gear, 36 . . . sleeve, 40, 60 . . . gear, 45 . . . tool bit, 49 . . . piston, 50 . . . striker, 52 . . . intermediate member, 53 . . . motion conversion mechanism, 58 . . . impact sleeve, 62 . . . hammer, 63 . . . ball, 66 . . . clutch, 73 . . . lever, 74 . . . first slide member, 75 . . . second slide member, 78 . . . first cam member, 79 . . . second cam member, C . . . center line

1-24. (canceled)

25. A power tool, which holds a tool bit and transmits a rotational force of a rotary member to the tool bit, the power tool being switchable between an impact mode in which the rotational force of the rotary member is transmitted as a striking force in a rotation direction of the tool bit and a hammer mode in which the rotational force of the rotary member is transmitted as a striking force in a linear motion direction of the tool bit without converting the rotational force into a striking force in the rotation direction of the tool bit.

26. The power tool according to claim 25,
wherein a drill mode in which the rotational force of the rotary member is transmitted to the tool bit without converting the rotational force into the striking force in the rotation direction of the tool bit is singly selectable.

27. The power tool according to claim 25,
wherein a hammer drill mode in which the rotational force of the rotary member is transmitted as a rotational force of the tool bit and the striking force in the linear motion direction is singly selectable.

28. The power tool according to claim 25, further comprising:
a tube-shaped cylinder which holds the tool bit; and a hammer which is provided coaxially with a center line of the cylinder on an outer circumferential side of the cylinder and is movable in a direction along the center line.

29. The power tool according to claim 28,
wherein a piston provided to be reciprocally movable, a striker which generates a striking force in a linear motion direction by reciprocal movements of the piston, and an intermediate member which transmits the striking force of the striker to the tool bit are provided in the cylinder.

30. The power tool according to claim 29, the power tool being switchable between the impact mode in which the rotational force is transmitted as a striking force in a rotation direction to the tool bit via the hammer and the hammer mode in which the rotational force is transmitted as a striking force in a linear motion direction to the tool bit via the piston, the striker and the intermediate member.

31. A power tool, which holds a tool bit and transmits a rotational force of a rotary member to the tool bit, the power tool comprising:
a first power transmitting mechanism for converting the rotational force of the rotary member into a striking force in a rotation direction and transmitting the striking force to the tool bit;
a second power transmitting mechanism for transmitting the rotational force of the rotary member to the tool bit without converting the rotational force into a striking force in the rotation direction;
a third power transmitting mechanism for converting the rotational force of the rotary member into a striking force in a linear motion direction and transmitting the striking force to the tool bit without converting the rotational force into the striking force in the rotation direction; and
a switching mechanism capable of switching modes between an impact mode in which the rotational force of the rotary member is transmitted to the first power transmitting mechanism and a hammer drill mode in which the rotational force of the rotary member is transmitted to the second power transmitting mechanism and the third power transmitting mechanism.

32. The power tool according to claim 31,
wherein the first power transmitting mechanism includes: a tube-shaped cylinder which holds the tool bit therein; a first driven gear which can be rotated relatively to the cylinder and to which the rotational force from the rotary member is transmitted; and a hammer which converts a rotational force of the first driven gear into a striking force in the rotation direction and transmits the striking force to the cylinder,
the second power transmitting mechanism includes a second driven gear to which the rotational force from the rotary member is transmitted and which is rotated integrally with the cylinder, and
the third power transmitting mechanism includes: a piston provided in the cylinder so as to be reciprocally movable; a striker which is provided in the cylinder and generates a striking force in a linear motion direction by reciprocal movements of the piston; and an intermediate member which is provided in the cylinder and transmits the striking force of the striker to the tool bit.

33. The power tool according to claim 32,
wherein the switching mechanism includes: a clutch which is rotated integrally with the rotary member and can move in a direction along a center line of the rotary member; a tube-shaped member which is provided so as to be rotatable with respect to the rotary member and to be movable in the direction along the center line; and a plurality of driving gears which are provided on an outer circumferential surface of the tube-shaped member and are selectively meshed with the first driven gear and the second driven gear.

34. The power tool according to claim 30,
wherein the switching mechanism can switch modes among a drill mode in which a path for transmitting the rotational force of the rotary member to the second power transmitting mechanism is connected and a path for transmitting the rotational force of the rotary member to the first power transmitting mechanism and the third power transmitting mechanism is disconnected, a neutral mode in which all the paths for transmitting the rotational force of the rotary member to the first to third power transmitting mechanisms are disconnected, and a hammer mode in which a path for transmitting the rotational force of the rotary member to the third power transmitting mechanism is connected and a path for transmitting the rotational force of the rotary member to the first power transmitting mechanism and the second power transmitting mechanism is disconnected.

35. The power tool according to claim 34,
wherein the rotational force of the rotary member is not transmitted as the striking force in the rotation direction to the tip tool in the drill mode, the hammer mode and the hammer drill mode.

36. A power tool, which holds a tool bit and transmits a rotational force of a motor to the tool bit through a rotary member, the power tool comprising:
a plurality of power transmission paths for transmitting the rotational force of the rotary member to the tool bit; and
a switching mechanism for switching the plurality of power transmission paths,
wherein the switching mechanism includes two independent switching members which can move coaxially with the rotary member and connect or disconnect the rotary member and the plurality of power transmission paths.

37. The power tool according to claim 36,
wherein the switching mechanism includes an operation member which is operated by a worker,
the switching member is moved by operating the operation member and includes: a first moving member which can move with respect to the rotary member; and a second moving member which comes close to or separates from the first moving member, and
when the operation member is operated, at least one of the first moving member and the second moving member is moved, so that the plurality of power transmission paths are switched.

38. The power tool according to claim 37,
wherein the switching mechanism includes: a first slide member which moves the first moving member along with the operation of the operation member; and a second slide member which moves the second moving member along with the operation thereof, and
the operation member connects or disconnects the rotary member and the plurality of the power transmission paths by moving the first slide member and the second slide member along the center line of the rotary member.

39. The power tool according to claim 37,
wherein the operation member includes: a lever which rotates around an axial line intersecting with the center line by the operation of the worker; a first cam member which is attached to the lever and rotates integrally with the lever to come in contact with the first slide member; and a second cam member which is attached to the lever and rotates integrally with the lever to come in contact with the second slide member.
